(19) United States
(12) Patent Application Publication
(10) Pub. No.: US 2013/0024400 A1
(43) Pub. Date: Jan. 24, 2013

(54) ADVANCED MODELING OF PRINTED CIRCUIT BOARD COSTS

(71) Applicants: Casimer M. DeCusatis, Poughkeepsie, NY (US); George A. Katopis, Poughkeepsie, NY (US); Roger S. Krabbenhoft, Rochester, MN (US); Todd A. Nelson, Austin, TX (US); Sreekanth Ramakrishnan, Hopewell Junction, NY (US); Anuradha Rao, Hopewell Junction, NY (US); Joseph H. Torella, Lagrangeville, NY (US)

(72) Inventors: Casimer M. DeCusatis, Poughkeepsie, NY (US); George A. Katopis, Poughkeepsie, NY (US); Roger S. Krabbenhoft, Rochester, MN (US); Todd A. Nelson, Austin, TX (US); Sreekanth Ramakrishnan, Hopewell Junction, NY (US); Anuradha Rao, Hopewell Junction, NY (US); Joseph H. Torella, Lagrangeville, NY (US)

(73) Assignee: International Business Machines Corporation, Armonk, NY (US)

(21) Appl. No.: 13/184,832

(22) Filed: Jul. 18, 2011

(51) Int. Cl. G06Q 10/00

(52) U.S. Cl. 705/400

(57) ABSTRACT

A total cost estimate is calculated based on a set of printed circuit board (PCB) design parameters. The set of PCB design parameters are received, and PCB attributes are extracted from them. Based on the PCB attributes the PCB is classified and a cost equation is calculated. The cost equation is calculated based on a regression analysis of one or more of the PCB attributes. Once the cost equation is calculated, the total cost is computed based on the cost equation.

### BACKGROUND

This invention relates generally to processing within a computing environment, and more particularly to advanced methods of modeling printed circuit board production costs.

In the modern electronics and computer industry, there is an ever-increasing demand for printed circuit boards (PCBs) of varying complexity and cost. Organizations often require as many as 400 different electronic PCBs to support even a single server group. The number of components on each card varies between 20 and 900, and the cost per card varies from as low as $5 to as high as $8,000 or more. Annual costs for card assembly for a corporation can run upwards of $1 billion. Therefore, lowering manufacturing costs or improving cycle time for card manufacturing can potentially have a large financial impact.

Estimating the costs of raw cards is an especially challenging task. There are numerous processes that are required to manufacture a raw card, and the cost can be influenced by design complexities (such as the presence of buried holes and vias, number of layers, number of holes to be drilled, use of gold conductors, and degree of customization in the design, to name only a few). Cost is also a function of the manufacturing process, the tools and skills available to the manufacturer, and other factors. Underestimating the production costs for a PCB can result in losses for a company, whereas overestimating the cost will take away the company competitive advantage.

### BRIEF SUMMARY

An embodiment includes a computer implemented method for advanced modeling of printed circuit board costs. The method includes receiving a set of PCB design parameters, and extracting PCB attributes from them. The method additionally includes determining a classification of the PCB based on the PCB attributes, and selecting a cost equation based on the classification. The cost equation is calculated based on a regression analysis of one or more of the PCB attributes. Once the cost equation is calculated, the total cost is computed based on the cost equation.

An additional embodiment includes a system for advanced modeling of printed circuit board costs, the system including a computer processor configured to execute a modeling module, the modeling module performing a method. The method includes receiving a set of PCB design parameters, and extracting PCB attributes from them. The method additionally includes determining a classification of the PCB based on the PCB attributes, and selecting a cost equation based on the classification. The cost equation is calculated based on a regression analysis of one or more of the PCB attributes. Once the cost equation is calculated, the total cost is computed based on the cost equation.

A further embodiment includes a computer program product, the computer program product including a tangible storage medium readable by a processing circuit and storing instructions for execution by the processing circuit, the instructions performing a method for advanced modeling of printed circuit board costs. The method includes receiving a set of PCB design parameters, and extracting PCB attributes from them. The method additionally includes determining a classification of the PCB based on the PCB attributes, and selecting a cost equation based on the classification. The cost equation is calculated based on a regression analysis of one or more of the PCB attributes. Once the cost equation is calculated, the total cost is computed based on the cost equation.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 depicts a schematic diagram of a PCB cost modeling system that may be implemented by an embodiment;

FIG. 2 depicts a process flow that may be implemented to perform advanced modeling of PCB costs in an embodiment;

FIG. 3 depicts a diagram of the circuit board attributes in an embodiment;

FIG. 4 depicts a PCB classification grid that may be used to classify a PCB in an embodiment; and

FIG. 5 depicts a process flow that may be used to generate a regression equation for use in regression analysis in an embodiment.

### DETAILED DESCRIPTION

An embodiment of the present invention provides for advanced modeling of PCB costs. In an embodiment, the design parameters for a PCB are received from a customer in a standard format. Data is extracted from the design parameters, and the product attributes are determined from the data. A product model classification is determined based on the product attributes, and then one of a number of cost prediction equations is selected. The equations are selected to best model the production costs based on the product model classification. Regression analysis is used to calculate a manufacturer's value added costs based n the product attributes. The model classification is used to identify additional costs based on criteria such as anticipated yield, materials of the board, the amount of the panel that is utilized and other factors. A total cost is then calculated based on the regression analysis and the additional costs. Once the manufacturer process is completed, the actual costs are compared to the predicted costs and an error function is determined that can be used to adjust future predictions. A knowledge base that is used to feed variables to the prediction models is then updated based on calculations derived from applying the error function to the regression analysis equation. The updated information is then used in subsequent regression analyses, which will result in progressively more accurate cost estimates over time.

This approach reduces the cycle time of cost estimation from days or weeks to near real time, and increases the accuracy and repeatability of cost estimates. In an embodiment, the circuit board cost modeling additionally assess use of precious metals and estimate based on links to current mercantile exchange rates. The circuit board cost modeling calculates total cost estimates based on the above factors, includes standard deviation and R-squared fit parameters for available data history, calculates error function between predicted and actual values, and dynamically updates regression equations with error function information to improve subsequent cost estimates.

In an embodiment, the PCBs are divided into four classifications based on high/low complexity and high/low cost. For each of the classifications developed in this manner, there is a different historical database of similar card designs. In an embodiment, the automated classification selection is manually overridden and any classification may be applied to the PCB design. Each of the classifications has a different mathematical distributions of attributes, so each classification requires a different equation for regression analysis, as will be described in more detail below. The determination of which classification to automatically apply to a PCB design is based on the use of statistical analysis to evaluate which data sets are well clustered with a suitably low statistical variance within the data set but a high degree of variance between data sets. The inclusion of more or less attributes in the classification may facilitate this analysis. Although four classifications are depicted, it will be understood that in additional embodiments any number of classifications and attributes may be used.

In an embodiment, an error in the bidding process, such as an underbid or overbid, is determined by comparing the value calculated by the PCB model with the variance (R squared value) of the historical data set. Outlying data points may indicate either an error in the bidding process, an inexperienced bidder, an attempt to bid low just to win the business, or an attempt to bid high and extract unjustified profit margins. Other advantages of this approach include improving the accuracy of card manufacturing bids, reducing the time to estimate card cost from days or weeks to near real time, removing the objective components from the bid process, and ease of including new features such as supplier history or mercantile exchange rate in the bidding process.

In an embodiment, various what if scenarios may be tested in order to determine the most cost effective approach to the PCB design and manufacture. Existing card designs may be tested and tweaked in order to reduce cost. Because the turn around time for generating estimates is minutes as opposed to weeks, various versions of a PCB design may be tested using various materials, components, and manufacturing options, each of which is estimated in order to optimize the design and production of a PCB.

Although it is very important to accurately estimate the costs beforehand, the current state of the art is not well developed. A number of cost estimation approaches are available. These include intuitive estimation (which relies on the experience and skill of the designer to guess the cost range); variant-based estimation (which estimates the cost of a product based on known cost of similar products manufactured earlier); and parametric estimation (which attempts to identify leading cost contributors to the card design as a basis for determining the final cost). All of these techniques have obvious disadvantages, including a long cycle time (several days or weeks). They are also not based on an objective, repeatable, quantifiable approach.

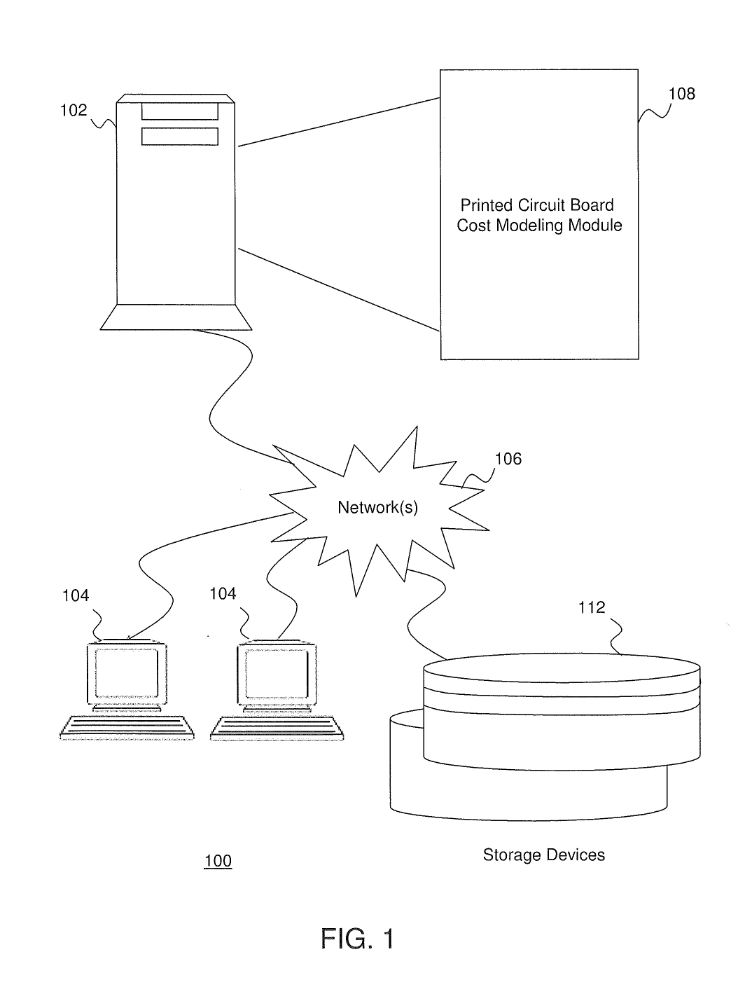

Turning now to FIG. 1, a system 100 for implementing PCB cost modeling will now be described. In an embodiment, the system 100 includes a host system computer 102 executing computer instructions for PCB cost modeling. Host system computer 102 may operate in any type of environment that is capable of executing a software application. Host system computer 102 may comprise a high-speed computer processing device, such as a mainframe computer, to manage the volume of operations governed by an entity for which the PCB cost modeling is executing. In an embodiment, the host system computer 102 is part of an enterprise (e.g., a commercial business) that implements the PCB cost modeling.

In an embodiment, the system 100 depicted in FIG. 1 includes one or more client systems 104 through which users at one or more geographic locations may contact the host system computer 102. The client systems 104 are coupled to the host system computer 102 via one or more networks 106. Each client system 104 may be implemented using a general-purpose computer executing a computer program for carrying out the processes described herein. The client systems 104 may be personal computers (e.g., a lap top, a personal digital assistant, a mobile device) or host attached terminals. If the client systems 104 are personal computers, the processing described herein may be shared by a client system 104 and the host system computer 102 (e.g., by providing an applet to the client system 104). Client systems 104 may be operated by authorized users (e.g., programmers) of the PCB cost modeling system described herein.

The networks 106 may be any type of known network including, but not limited to, a wide area network (WAN), a local area network (LAN), a global network (e.g., Internet), a virtual private network (VPN), and an intranet. The networks 106 may be implemented using a wireless network or any kind of physical network implementation known in the art. A client system 104 may be coupled to the host system computer 102 through multiple networks (e.g., intranet and Internet) so that not all client systems 104 are coupled to the host system computer 102 through the same network. One or more of the client systems 104 and the host system computer 102 may be connected to the networks 106 in a wireless fashion. In one embodiment, the networks 106 include an intranet and one or more client systems 104 executing a user interface application (e.g., a web browser) to contact the host system computer 102 through the networks 106. In another embodiment, the client system 104 is connected directly (i.e., not through the networks 106) to the host system computer 102 and the host system computer 102 contains memory for storing data in support of PCB cost modeling. Alternatively, a separate storage device (e.g., storage device 112) may be implemented for this purpose.

In an embodiment, the storage device 112 includes a data repository with data relating to PCB cost modeling by the system 100, as well as other data/information desired by the entity representing the host system computer 102 of FIG. 1. The storage device 112 is logically addressable as a consolidated data source across a distributed environment that includes networks 106. Information stored in the storage device 112 may be retrieved and manipulated via the host system computer 102 and/or the client systems 104. In an embodiment, the storage device 112 includes one or more databases containing, e.g., historical modeling and manufacturing data and corresponding configuration parameters, values, methods, and properties, as well as other related information as will be discussed more fully below. It will be understood by those of ordinary skill in the art that the storage device 112 may also comprise other structures, such as an XML file on the file system or distributed over a network (e.g., one of networks 106), or from a data stream from another server located on a network 106. In addition, all or a portion of the storage device 112 may alternatively be located on a client system 104.

The host system computer 102 depicted in the system of FIG. 1 may be implemented using one or more servers operating in response to a computer program stored in a storage medium accessible by the server. The host system computer 102 may operate as a network server (e.g., a web server) to communicate with the client systems 104. The host system computer 102 handles sending and receiving information to and from the client systems 104 and can perform associated tasks. The host system computer 102 may also include a firewall to prevent unauthorized access to the host system computer 102 and enforce any limitations on authorized access. For instance, an administrator may have access to the entire system and have authority to modify portions of the system. A firewall may be implemented using conventional hardware and/or software as is known in the art.

The host system computer 102 may also operate as an application server. The host system computer 102 executes one or more computer programs to provide PCB cost modeling. The host system computer 102 includes a PCB cost modeling module 108. As indicated above, processing may be shared by the client systems 104 and the host system computer 102 by providing an application (e.g., java applet) to the client systems 104. Alternatively, the client system 104 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

It will be understood that the PCB cost modeling described in FIG. 1 may be implemented in hardware, software executing on a general purpose computer, or a combination thereof.

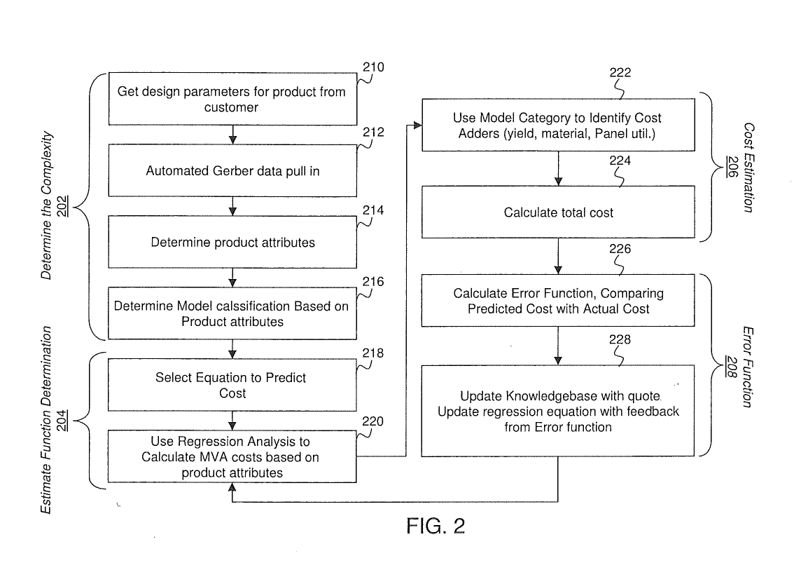

FIG. 2 is a process flow that may be implemented to perform advanced modeling of PCB costs in an embodiment. In an embodiment, the process flow of FIG. 2 is executed by the PCB cost modeling module 108 of FIG. 1. The blocks of the process flow are divided into four components, complexity determination component 202, a cost function determination component 204, a cost estimation component 206 and an error adjustment component 208. In an embodiment all of the components are executed on the PCB cost modeling module 108 of FIG. 1. In an alternate embodiment, each component may be executed by a distinct module or other hardware device (not shown). The four components may be executed sequentially in real time, or may be executed over time. For example, the error adjustment component 208 may be executed several days, weeks, or even months after the other components have completed. At block 210, design parameters for a product are received. The design parameters are received in a standard format (e.g. a gerber design file). In an alternate embodiment, the design parameters may be received in any format suitable for representing the circuit board design and its components, such as a proprietary format. At block 212, data is extracted from the received design parameters.

At block 214, the product attributes are determined. The product attributes include a number of qualitative and quantitative attributes of the PCB and the PCB's components as will be described in more detail below. At block 216 a model classification is selected based on the product attributes. In an embodiment, the model classification is selected based on the PCB's cost and complexity. Four model classifications are used, a model classification for high cost and high complexity circuit boards, a model classification for high cost and low complexity circuit boards, a model classification for high complexity and low cost circuit boards, and a model classification for low complexity and low cost boards. The model classification is selected based on the attribute types, as well as their values. In an embodiment, a user can override the automatically selected model classification. The use of four model classifications is for clarity, and it will be understood that, in other embodiments, any number of model classifications may be used based on any number of attributes and attribute values.

At block 218, a cost equation is selected based on the model classification. A different cost equation is used based on the specific model classification that has been selected either automatically, or by manual override. Each of the cost equations are determined based on a statistical analysis as will be described in more detail below. At block 220, regression analysis is applied to the cost function based on the attributes and a base cost is determined. At block 222, cost adders are determined based on the model classification. Cost adders are additional costs that are expected to be incurred based on the complexity of the circuit boards. The expected yield of the completed boards may increase costs. For example, a circuit board that is highly complex may have a higher failure rate than a less complex board. This higher failure rate means a lower yield and therefore more waste, and more cost. Variability in the price of materials, such as gold or copper, may also be used as a cost adder. In addition, the amount of a manufacturer's panel that is wasted based on the circuit boards size or shape creates additional costs. Each manufacturer has one or more standard panel sizes. Often multiple circuit boards will fit on a single panel. Based on the size and shape of the circuit board, a certain amount of the panel may go unused. The more waste there is from a panel, the more expensive the production run will be. In an embodiment, the PCB cost modeling module 108 of FIG. 1 determines, based on the dimensions of the circuit board, and the dimensions of the panel, the amount of waste in the board.

At block 224, the base cost and the adder costs are calculated and summed to generate a total cost projection and the total cost projection is stored in the database. At block 226, an error function is calculated. When an actual price quotation is received from the manufacturer in response to a request for quote (RFQ), it is stored in the database. An error function is calculated based on the difference between projected cost and actual manufacturer price quotation. A regression analysis is run at this time and/or when a collection of quotes and the coefficients of the model equations are updated. In an embodiment, the error function is calculated based on the difference between the total cost projection, and the actual cost of manufacturing the circuit boards. At block 228, the knowledge base is updated with quote information from the manufacturers (i.e., quotes in response to a request for quote based on the circuit board), the actual costs of manufacture, and adjustments are made to the knowledge base using the error function that has been calculated. In an embodiment, the knowledge base may be updated at any point before, during or after the process flow of FIG. 2 based on any new information received from manufacturer quotes, actual production costs, and error functions from any previously quoted or manufactured circuit boards.

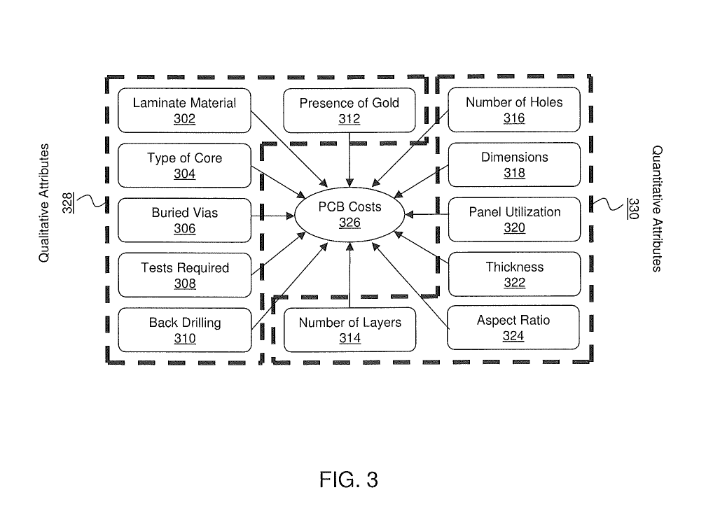

FIG. 3 depicts a diagram of the circuit board attributes in an embodiment. The circuit board attributes include a set of qualitative attributes 328, and a set of quantitative attributes 330. The qualitative attributes 328 include the laminate material 302 used to create the PCB; the type of core 304 used in the PCB, the number of buried vias 306 used in the PCB; the kinds of tests 308 that are required to ensure that a completed PCB is functioning properly. The qualitative attributes 328 additionally include if back drilling 310 is required. The presence of gold 312 or copper is another of the qualitative attributes 328. Other qualitative attributes include the registration tolerance of the PCB, and the impedance control requirements of the PCB design.

The quantitative attributes 330 include the number of holes 316 that are needed, the PCB dimensions 318, the panel utilization 320, the thickness of the PCB 322, the aspect ration 324 of the PCB, and the number of layers 314 of the PCB. One or more of these attributes are used as input into determining the PCB costs 326.

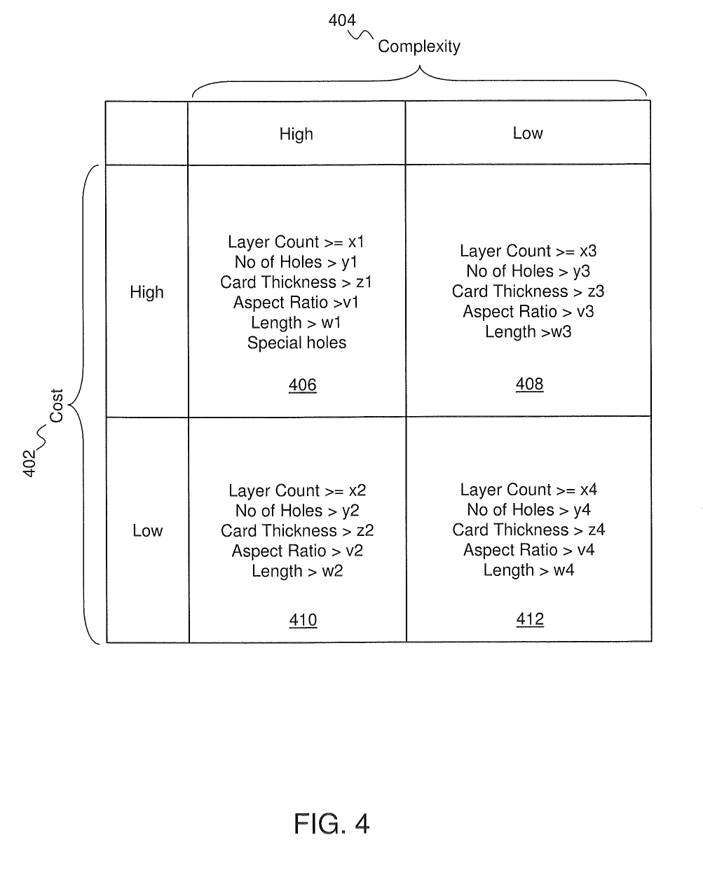

FIG. 4 depicts a PCB classification grid that may be used to classify a PCB in an embodiment. FIG. 4 depicts one embodiment with a four-part classification. It will be understood that any number of classifications may be used in additional embodiments. In addition, the specific examples and values are used for purposes of clarity and it will be understood that in additional embodiments, any values may be used. The cost 402 and complexity 404 are divided into high and low segments based on the attribute values. The table of FIG. 4 depicts the attributes values for a high cost, high complexity classification 406, a high cost, low complexity classification 408, a low cost high complexity classification 410, and a low cost low complexity classification 412. In an embodiment, the attribute values that make up each classification are adjusted over time, as factors in the industry change. In an additional embodiment, the attribute values that make up each classification are user selectable for each specific PCB.

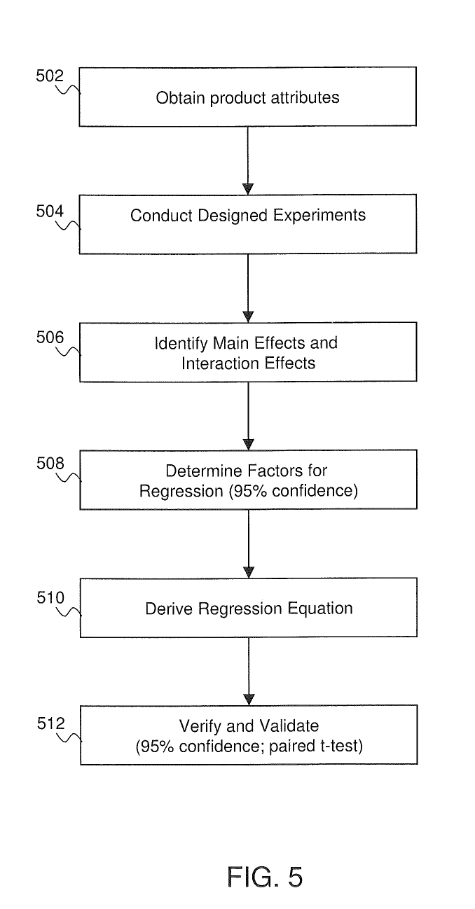

FIG. 5 depicts a process flow that may be used to generate a regression equation for use in regression analysis in an embodiment. In an embodiment, the regression equation generated by the process flow of FIG. 5 is used in the regression analysis block 220 of FIG. 2. At block 502, a set of attributes, such as the attributes described above in FIG. 3, are extracted from a knowledge base. The knowledge base includes one or more historical data from previous estimates, manufacturer's quotes, and detailed information about manufacturers. The detailed information about the manufacturers' include one or more of manufacturing capabilities and capacity, materials, specifications, acceptable profit margins, the manufacturers' specializations, a match between the requirements and the qualification requirements of the person, department, or company that is creating the PCB design, the geographic differences between the various manufacturers (i.e., the labor rate, shipping costs, taxes, etc.) or any other relevant information about the manufacturers. Using the information in the knowledge base, a regression equation may be generated based on a specific manufacturer, a generic manufacturer (i.e. a model manufacturer), or the analysis may be run to determine the best manufacturer based on a specific set of product attributes.

At block 504, design experiments are performed. In an embodiment, the various attributes are tested and the effect on the costs are determined. For example, various thicknesses of the cards are plotted against the mean cost for each thickness. At block 506, the design experiment results are plotted in order to determine the main effects and interactions of the various attributes. By plotting the variation on the attributes against their mean costs, the main effects of changes in the design requirements can be effectively determined. In some cases a change in one attribute will, by extension, correlate directly with a change in another. For example, as the area of a board increases, the number of holes in the board will typically also increase. This may cause a double counting of the costs (e.g. adding costs based on the number of holes, and the area may cause an over estimate since the cost of increasing the board size likely already includes the additional cost of the added hole count.) In an embodiment, the interactions between various components are plotted in order to reduce or eliminate the double counting. At block 508, the factors for regression are calculated using statistical analysis of the various attributes and their impact on cost. At block 510, a regression equation is calculated for each of the classifications, such as the classifications of FIG. 4, based on the regression factors. At block 512, the regression equations are tested and verified against known PCB costs.

In an embodiment, the equations determined at block 512 are as follows:

costEstimate=(K 1)+a1*Cardthickness+b1*.Holes−c1*Cardwidth+d1*Cardlength+e1*No. of Layers+f1*Heavycopperlayersp−g1*Panelutilization/100; HCHC (High Complexity High Cost)

costEstimate=(K2)−a2*Cardthickness+b2*No. of Holes−c2*Cardwidth+d2*Cardlength+e2*No. of Layers+f2*Heavycopperlayers+g2*Panelutilization/100; HCHC (High Complexity High Cost)

costEstimate=K3)+a3*Cardthickness+b3*No. of Holes+c3*Cardwidth+d3*Cardlength+e3*No. of Layers+f3*Heavycopperlayer−g3*Panelutilization/100; LCHC (Low Complexity High Cost)

costEstimate=(k4)+a4*Cardthickness+b4*No. of Holes+c4*Cardwidth+d4*Cardlength+e4*No. of Layers−f4*No. of Heavycopperlayers−g4*Panelutilization/100 LCLC (Low Complexity Low Cost)

The equations list above are provided for purposes of clarity only, and it will be understood that these equations are calculated based on blocks of FIG. 5 as needed, and therefore may vary as needed based on market conditions. In an embodiment, two or more equations may be averaged together to create a cost estimate.

Technical effects and benefits include the ability to quickly and accurately generate cost projections for a printed circuit board design. An additional benefit is the ability to support a what/if analysis by allowing a user to quickly identify the cost differences of different layouts, components, and manufacturers in order to create an optimal design. Yet another benefit is the ability to determine if a bid is too high or too low based on objective statistical analysis. Other benefits include improving the accuracy of card manufacturing bids, reducing the time to estimate card cost from days or weeks to near real time, removing the objective components from the bid process, and the ease of including new features such as supplier history or mercantile exchange rate in the bidding process

The terminology used herein is for the purpose of describing particular embodiments only and is not intended to be limiting of the invention. As used herein, the singular forms“a”,“an” and“the” are intended to include the plural forms as well, unless the context clearly indicates otherwise. It will be further understood that the terms “comprises” and/or“comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a“circuit,” “module” or“system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the“C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or schematic diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As described above, embodiments can be embodied in the form of computer-implemented processes and apparatuses for practicing those processes. In embodiments, the invention is embodied in computer program code executed by one or more network elements. Embodiments include a computer program product on a computer usable medium with computer program code logic containing instructions embodied in tangible media as an article of manufacture. Exemplary articles of manufacture for computer usable medium may include floppy diskettes, CD-ROMs, hard drives, universal serial bus (USB) flash drives, or any other computer-readable storage medium, wherein, when the computer program code logic is loaded into and executed by a computer, the computer becomes an apparatus for practicing the invention. Embodiments include computer program code logic, for example, whether stored in a storage medium, loaded into and/or executed by a computer, or transmitted over some transmission medium, such as over electrical wiring or cabling, through fiber optics, or via electromagnetic radiation, wherein, when the computer program code logic is loaded into and executed by a computer, the computer becomes an apparatus for practicing the invention. When implemented on a general-purpose microprocessor, the computer program code logic segments configure the microprocessor to create specific logic circuits.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer implemented method comprising:
receiving a set of printed circuit board (PCB) design parameters;
extracting PCB attributes from the PCB design parameters;
determining a classification of the PCB based on the PCB attributes;
selecting a cost equation based on the classification, the cost equation calculated based on a regression analysis of one or more of the PCB attributes; and
calculating a total cost based on the cost equation.

2. The method of claim 1, wherein the determining of the classification is responsive to mapping the PCB design parameters to a PCB classification.

3. The method of claim 1, wherein the classification is manually overridden.

4. The method of claim 2, further comprising calculating cost adders based on the PCB attributes.

5. The method of claim 4, wherein the calculating of the total cost comprises adding a result of the cost equation with a sum of the cost adders.

6. The method of claim 1, wherein the total cost is compared to a manufacturer's estimate to determine if the manufacturer has over bid, or under bid the estimate.

7. The method of claim 1, wherein the calculating further comprises using values from a knowledge base in the cost equation.

8. The method of claim 7, wherein an actual manufacturing cost is determined, an error function is calculated by comparing the actual manufacturing cost to the total cost, and the knowledge base is updated using the error function.

9. A system comprising:
a computer processor configured to execute a modeling module, the modeling module performing:
receiving a set of printed circuit board (PCB) design parameters;
extracting PCB attributes from the PCB design parameters;
determining a classification of the PCB based on the PCB attributes;
selecting a cost equation based on the classification, the cost equation calculated based on a regression analysis of one or more of the PCB attributes; and
calculating a total cost based on the cost equation.

10. The system of claim 9, wherein the determining of the classification is responsive to mapping the PCB design parameters to a PCB classification.

11. The system of claim 9, wherein the classification is manually overridden.

12. The system of claim 10, further comprising calculating cost adders based on the PCB attributes.

13. The system of claim 12, wherein the calculating of the total cost comprises adding a result of the cost equation with a sum of the cost adders.

14. The system of claim 9, wherein the total cost is compared to a manufacturer's estimate to determine if the manufacturer has over bid, or under bid the estimate.

15. The system of claim 9, wherein the calculating further comprises using values from a knowledge base in the cost equation.

16. The system of claim 15, wherein an actual manufacturing cost is determined, an error function is calculated by comparing the actual manufacturing cost to the total cost, and the knowledge base is updated using the error function.

17. A computer program product comprising:
a tangible storage medium readable by a processing circuit and storing instructions for execution by the processing circuit for performing a method, comprising:
receiving a set of printed circuit board (PCB) design parameters;
extracting PCB attributes from the PCB design parameters;
determining a classification of the PCB based on the PCB attributes;
selecting a cost equation based on the classification, the cost equation calculated based on a regression analysis of one or more of the PCB attributes; and
calculating a total cost based on the cost equation.

18. The computer program product of claim 17, wherein the determining of the classification is responsive to mapping the PCB design parameters to a PCB classification.

19. The computer program product of claim 17, wherein the calculating further comprises using values from a knowledge base in the cost equation.

20. The computer program product of claim 19, wherein an actual manufacturing cost is determined, an error function is calculated by comparing the actual manufacturing cost to the total cost, and the knowledge base is updated using the error function.
